(19) United States
(12) Patent Application Publication
(10) Pub. No.: US 2005/0028344 A1
(43) Pub. Date: Feb. 10, 2005

(54) Process for manufacturing a faceplate with a gasket member

(76) Inventor: Mark Jeffries, Cumming, GA (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/645,005

(22) Filed: Aug. 21, 2003

Related U.S. Application Data
(60) Provisional application No. 60/405,470, filed on Aug. 22, 2002.

(51) Int. Cl. E05B 3/00; B23P 11/00

(52) U.S. Cl. 29/464; 29/428; 29/525.01; 29/525.13; 292/348

(57) ABSTRACT

Methods (processes) are employed for forming a pan with an attached gasket, from universal pans and gaskets. These universal pans and gaskets are attached to each other and cut to a desired shape, resulting in a faceplate.

### CROSS REFERENCES TO RELATED APPLICATIONS

This application is related to and claims priority from U.S. Provisional Patent Application Ser. No. 60/405,470, filed Aug. 22, 2002, entitled: PROCESS FOR MANUFACTURING A UNITARY FACEPLATE AND GASKET MEMBER. U.S. Provisional Patent Application Ser. No. 60/405,470 is incorporated by reference herein.

### FIELD OF THE INVENTION

The present invention relates to a method for manufacturing a unitary faceplate, from a pan member and gasket member, used in, for example, latching systems. The faceplate member includes a sealing gasket permanently attached prior to shaping the faceplate, whereby the gasket matches the final trim profile of the pan member of the faceplate.

### BACKGROUND OF THE INVENTION

Faceplates or pans are typically mounted on doors or similar structures and are used with a handle and locking system. The faceplate provides a substrate on which to mount the handle and covers the hole in the door or structure through which the handle passes. Most pans or faceplates have a mounting flange that contacts the surface of the door or structure and is either round, rectangular, or pentagonal with generous radii at all corners. When the pan is mounted to the face of a door, it is most often desirable to have a sealing gasket that resides between the flange face and door face. Thus, when the pan is secured to the door, the gasket is compressed and thereby provides a seal between the two surfaces that helps to eliminate penetration of water and other liquids in the space between the interfaces. It is aesthetically desirable for the outer periphery of the gasket to match the outer periphery of the flange on the pan.

Gaskets for use as a seal are generally made from an elastomeric material. The gaskets can be stamped from sheet stock, or molded, and are cut to match the periphery of the pan. As such, the shape of the gasket is the same as the shape of the pan.

Presently, most gaskets are formed as separate pieces that are cut or molded to size and later attached to a pan that has already trimmed around its periphery. When supplied this way, the installer has to align the periphery of the gasket with the periphery of the pan during the installation process. This is often a difficult process, and it is common for the gaskets to not be aligned with the periphery of the pan.

In some molded gasket designs, a small raised lip around the entire periphery of the gasket is added to help locate the gasket relative to the peripheral edge of the pan. While the lip facilitates alignment between the gasket and the pan, the lip is of a limited height. Consequently, the lip does not ensure proper alignment. Additionally, if the lip is too thick, it can cause the pan to be misaligned with the gasket. Thus, a common problem is misalignment of the gasket with the periphery of the pan. Another problem is that, occasionally, the gasket will be applied upside down so that the raised lip is compressed onto the face of the door when the pan is installed.

To overcome some of these deficiencies, the gasket can be made as a separate piece and adhesively applied to the back of the flange as part of the manufacturing process. This eliminates the problems of misalignment of the gasket during installation by the user. However, in the manufacturing process, the outer periphery of the gasket has to be aligned with the outer periphery of the pan. This can be done by creating an assembly fixture that helps to align the items during assembly. The process is suitable for use with a simple flange shape; however, it becomes more difficult to achieve alignment as the flange profile becomes more complex.

As mentioned previously, most pans in current use have a periphery or edge of a simple shape, and the flange is usually either round, rectangular, or pentagonal with generous radii at all corners. The difficulty of aligning the gasket, as well as the current manufacturing methods for making the pan, make it undesirable for current manufacturers to offer a wider variety of outer peripheral shapes. In most cases, retooling would be required for each new shape. Moreover, most current manufacturing processes require longer production runs to be cost-effective, which leads to higher inventory requirements for each variation.

### SUMMARY OF THE INVENTION

The present invention improves on the contemporary art. The embodiments disclosed herein are directed to methods (processes) for forming a pan with an attached gasket, whereby the edges of the pan and gasket are unitary and can be of any of a variety of shapes and designs. The method includes attaching the gasket to the pan and then cutting the device to shape. In part, the invention relates to methods or processes for providing pans or faceplates, typically overlying gaskets, with any of a variety of peripheral shapes, that can be further worked, typically trimmed, into finished assemblies or products with a variety of peripheral shapes.

One embodiment resolves the potential manufacturing problems associated with trimming adhesive material that is sandwiched between the flange and the gasket while retaining all the benefits. The only compromise is the extra step of trimming the adhesive material as a separate operation.

The present invention provides numerous flange configurations that are unique and varied. At the same time, it provides an accurate method for aligning the gasket to more complex shapes. With this capability, customers can be provided with different and unique peripheral shapes that make the end products (faceplates with gasket members) more appealing and easier to install.

The present invention is directed to manufacturing processes that are cost-effective and flexible. In particular, these processes are flexible and do not have excessive tooling requirements. These processes do not require long production runs that lead to high inventory levels of the varied products. Most importantly, these processes provide a means to align the gaskets (gasket blanks) accurately with the respective pan (pan blanks).

An embodiment of the invention is directed to a process for forming a faceplate member or faceplate. This process includes providing an untrimmed pan blank, providing a gasket blank, attaching the gasket blank to the pan blank to form a subassembly, and trimming the subassembly to form a unitary pan and gasket member with substantially coincident peripheral edges. The gasket blank can include a first layer of adhesive material over a second layer of gasket material, with the adhesive layer for attaching to the pan blank. Alternately, the gasket blank may be a layer of gasket material with there being provided a separate adhesive member, that is placed intermediate the gasket blank and the pan blank prior to attaching the gasket blank to the pan blank.

Another embodiment is directed to a faceplate subassembly. This subassembly includes, a pan blank of a first predetermined configuration and a gasket blank of a second predetermined configuration. The pan blank is attached to the gasket blank such that upon trimming the subassembly into a third predetermined configuration, different than the first predetermined configuration and the second predetermined configuration, the outer peripheral edge of the remaining portion of the gasket blank is substantially coincident with the outer peripheral edge of the remaining portion of the pan blank.

### BRIEF DESCRIPTION OF THE DRAWINGS

Attention is now directed to the drawing figures, where like numerals and/or characters indicate corresponding or like components. In the drawings:

FIGS. 1A and 1B are respective front and rear exploded views of a pan blank and gasket blank prior to being attached in accordance with the present invention;

FIG. 2 is a perspective view of a faceplate subassembly where the pan blank and gasket blank are attached prior to trimming;

FIG. 3A is a perspective view of the subassembly of FIG. 2 with the resultant assembly shown in broken lines;

FIG. 3B is a front view of the subassembly of FIG. 2 with the resultant assembly shown in broken lines;

FIG. 4 is a perspective view of a finished faceplate after trimming;

FIG. 5 is an exploded view of a pan blank, adhesive member and gasket blank prior to being attached in accordance with a second embodiment of the present invention;

FIG. 6 is a front view of the faceplate subassembly of FIG. 5;

FIG. 7A is a front view of a finished faceplate in accordance with a second embodiment of the invention; and

FIG. 7B is a rear view of a finished faceplate in accordance with a second embodiment of the invention.

### DETAILED DESCRIPTION OF THE DRAWINGS

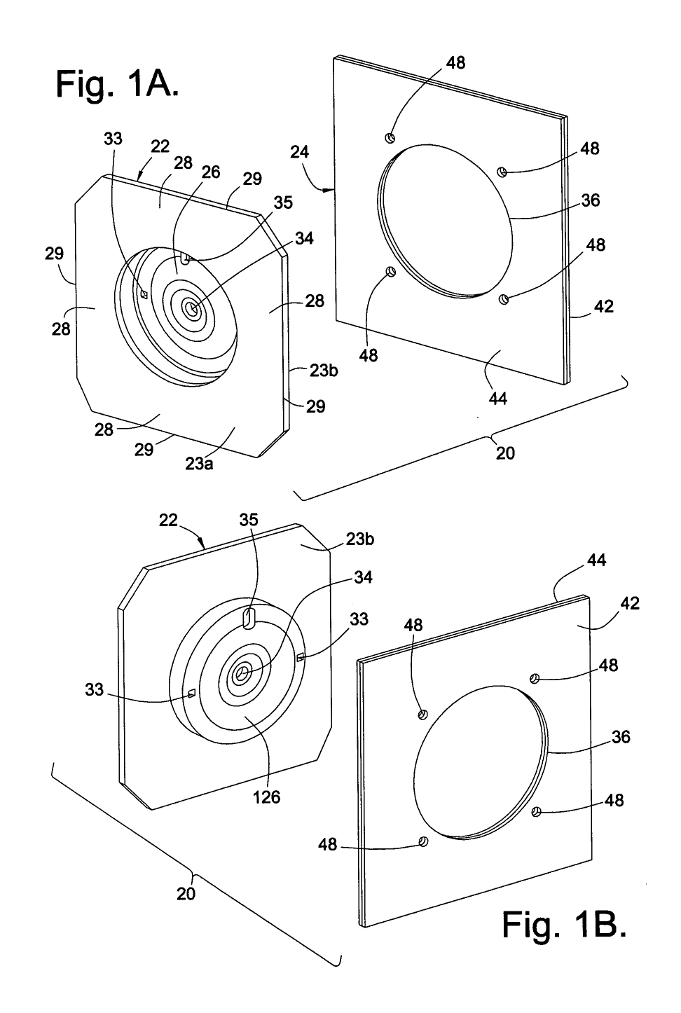

FIGS. 1A and 1B show a faceplate preassembly 20 in accordance with a first embodiment of the invention. This preassembly 20 includes a pan blank 22 and a gasket blank 24, shown in alignment, prior to being joined together.

The pan blank 22 has front 23a and rear 23b sides (in a typical orientation), and includes a recessed area 26 (here, extending rearward, in the direction of the rear side 23b), that has been drawn and formed, by conventional material (typically, metal) working techniques. Here, for example, the pan blank 20 originates as a metal sheet that is drawn and formed. The inner recessed area 26 is surrounded by flange portions or flanges 28, whose outer edges 29 define the periphery of the pan blank 22.

The outer peripheral profile of the pan blank 22 is not trimmed initially. The outer edges 29 remain untrimmed and can vary in dimension based on the material remaining in the flange portions 28. Common holes 33-35 can be punched into the pan blank 22.

The gasket blank 24 includes a gasket sheet or gasket sheet layer 42, typically of a polymeric or elastomeric material, and double-backed adhesive material layer 44 over the gasket sheet 42. This adhesive material layer 44 is joined to the gasket blank 24 and is part of the gasket blank 24. The gasket blank 24 can be applied to the rear side 23b of the pan blank 22 prior to punching the holes 33-35.

The gasket sheet 24 is stamped to approximately match, and typically extend beyond, the periphery of the pan blank 22. Here, for example, the pan blank 22 and the gasket blank 24 are typically rectangular or square in outer peripheral shape, so as to be universal and accommodate numerous shapes for the final assembly. However, other shapes for the pan blank 22 and gasket 24 are also suitable. The gasket blank 24 is typically stamped to form an opening 36, slightly larger in perimeter and corresponding to the shape of the recessed area 26. This stamping typically also includes removal of portions of the gasket blank 24 in areas where mounting holes 48 might exist around the flanges 28.

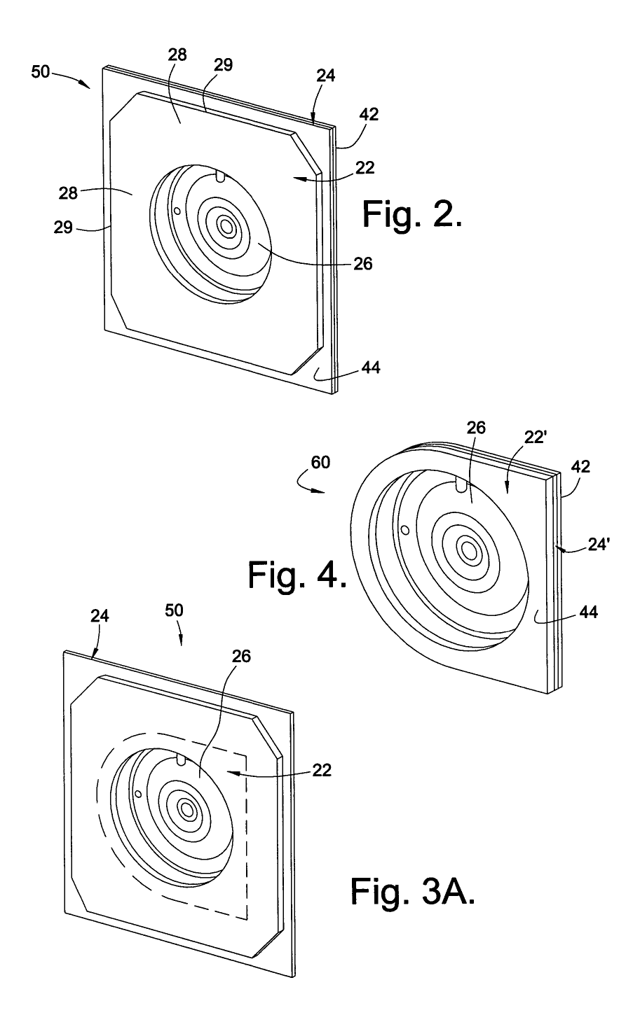

Once the gasket blank 24 is trimmed to remove the portion(s) corresponding in shape to the recessed area 26 of the pan blank 22, it is permanently attached to the rear side 23b of the pan blank 22 at the flange portions 28. This attachment forms a gasket and pan blank (faceplate) subassembly 50, as shown in FIG. 2. This subassembly 50 becomes the base part from which any final part (assembly) can be made in a subsequent process.

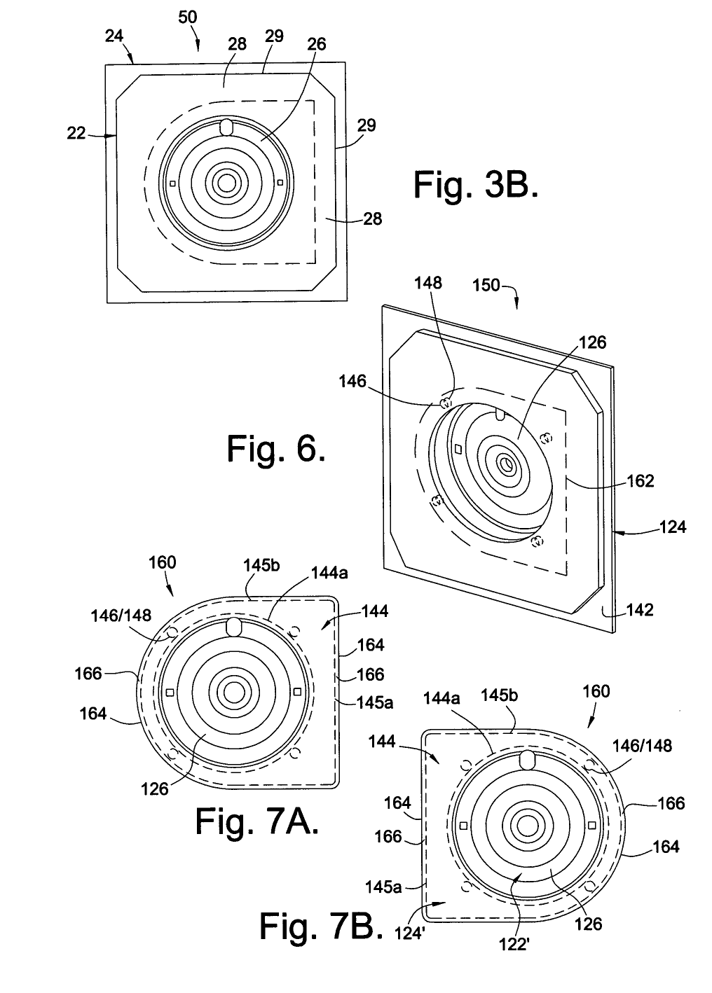

When a desired peripheral shape is selected, as shown in broken lines in FIGS. 3A and 3B, the gasket and pan blank (faceplate) subassembly 50 is loaded into the appropriate trimming die (not shown). This trimming die can be any conventional trimming die, as is known in the art. In the trimming die, the gasket blank 24 and pan blank 22 are trimmed simultaneously, so as to have the same peripheral profile. This results in a finished assembly or faceplate 60, shown in FIG. 4.

Since the gasket blank 24 is permanently attached to the rear side 23b of the pan blank 22, prior to trimming, and since both are trimmed simultaneously in the same tool (e.g., trim die), the gasket 24′ (formed from the trimmed gasket blank 24) will have the same or similar peripheral profile as the pan 22′ (formed from the pan blank 22), for example, coincident outer peripheral edge(s), regardless of its shape or complexity. This allows complex shapes, including even notched configurations, to be made without the gasket blank 24, that ultimately becomes the gasket 24′, being misaligned.

As a result of this process, large inventories of multiple finished items are not necessary. Here, for example, specific gaskets corresponding to their respectively shaped pans, are replaced by a universally shaped gasket blank 24 and a universally shaped pan 22, the gasket blank 24 for attachment to the pan blank 22 in a manner where the gasket blank 24 extends beyond the periphery of the pan blank 22 (and cut to accommodate the recessed area 26 of the pan blank 22). These universally sized gaskets and pans, when coupled together, with adhesives and the like, form gasket and pan blank subassemblies that can be later converted to any available configuration on a build-to-order basis. Since the pan/gasket flange area is manually trimmed at a later date by a trim die, the tooling costs to provide the finished product is reduced, when compared to pieces produced from large inventories of multiple finished items.

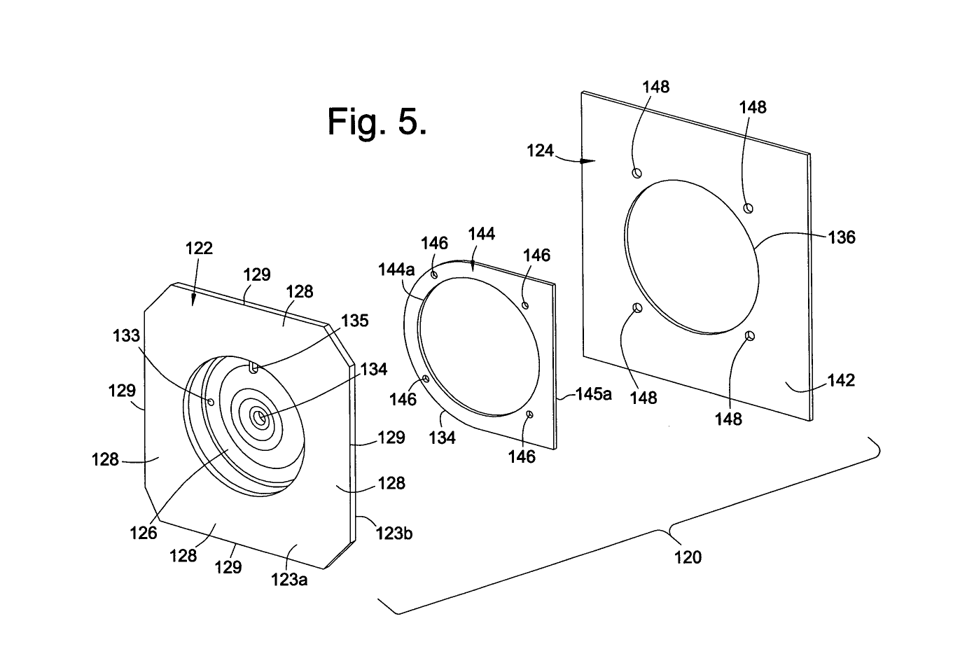

FIG. 5 shows a second embodiment of the invention. This embodiment includes a manufacturing process, that is similar to the manufacturing process for the first embodiment (FIGS. 1-4), as detailed above. In this second embodiment, components similar to those detailed in the first embodiment have their numbers increased by “100”.

This second embodiment is similar to the first embodiment, except that it uses a separate double-backed adhesive material member 144. As shown in FIG. 5, a faceplate preassembly 120 in accordance with this second embodiment has this separate double-backed adhesive material member 144 for bonding to the gasket blank 124 to the back of the flange portions 128 of the pan blank 122. This adhesive material member 144 is trimmed in a separate operation prior to assembly of the gasket blank 124 to the pan blank 122. The adhesive member 144 also includes an opening 144a for accommodating the recessed portion 126 of the pan blank 122 (typically corresponding in shape thereto, as detailed for openings 36 and 136, herein). Openings 146 for aligning with mounting holes 148 on the gasket blank are in the adhesive member 144.

Specifically, the adhesive material member 144 is first trimmed by a die as a separate piece. This trimming process is such that the trimmed peripheral edges 145a, 145b, are designed to reside inward by a small amount relative to the outer edges 129 of the respective flanges 128 of the pan blank 122, when it is subsequently trimmed. For example, in a finished assembly or faceplate 160, as shown in FIGS. 7A and 7B, a typical inward offset, of the edges 145a, 145b (shown in broken lines) of the adhesive member 144 from the outer edge 164, could be 0.040 inches.

In this second embodiment, the pan blank 122 is processed in the same way as the pan blank 22 in the first embodiment. The gasket blank 124 is also processed the same way as the gasket blank 24 in the first embodiment (including the stamping of the opening 136 to accommodate the recessed portion 126 of the pan blank 122), except that it is stamped into the pan blank 122 after the adhesive member 144 has been attached to the rear side 123b of the pan blank 122. Additionally, this gasket blank 124 differs from the gasket blank 24 of the first embodiment, as it is formed from a sheet (typically a layer) of gasket material 142 (typically polymeric or elastomeric) that lacks the (preattached) adhesive layer 44.

In this embodiment, the pan blank 122, the gasket blank 124, and the trimmed adhesive member 144 are separate items. The pan blank 122 and the gasket blank 124 are generic, typically rectangular or square in shape as detailed for the first embodiment above. The adhesive member 144, is a separate piece that is pre-trimmed, so it matches one or more of the desired final configurations. Therefore, an inventory of trimmed adhesive pieces (of which adhesive piece 144 is an example of) is required with this second embodiment.

In an exemplary process, when an available trim profile is requested, a generic pan blank 122 and a generic gasket blank 124 are selected with the appropriate trimmed adhesive member 144. The adhesive member is applied to the rear side 123b of the pan blank 122. The gasket blank 124 is then applied to the opposite and exposed side of the double sided adhesive member 144, by conventional stamping techniques.

Turning to FIG. 6, this application aligns the gasket blank 124, adhesive member 144 and pan blank 122, such that openings 136 and 144a in the gasket blank 124 and adhesive member, respectively, surround the recessed portion 126 of the pan blank 122. Additionally, the openings 146 of the adhesive member 144 align with the respective mounting holes 148 of the gasket blank 124. This application results in the gasket blank 124 being permanently, adhesively attached to the rear side 123b of pan blank 122 at the flanges 128. The adhesive member 144 (shown in broken lines in FIGS. 7A and 7B) remains intact between the pan blank 122 and the gasket blank 124, in the faceplate subassembly 150.

Alternately, the double sided adhesive member 144 can first be applied to the gasket blank 124. This gasket blank 124-adhesive member 144 is then joined to the pan blank 122, to form the subassembly 150. The alignments for the pan blank 122, adhesive member 144 and gasket blank 124 would be in accordance with those detailed immediately above.

The subassembly 150, is then put in the appropriate trim die, that simultaneously trims the pan blank 122 at the flange portions 128, and the gasket blank 124, in accordance with the configuration (trim line) of the desired finished assembly or faceplate 160, shown in broken lines 162. The trim die does not, however, during trimming, contact the adhesive member 144 in the subassembly 150 in any area of the trim.

Turning also to FIGS. 7A and 7B, since the periphery of the adhesive member 144 (shown in broken lines) was designed to be slightly smaller than the trim periphery (i.e., the outer peripheral edges 164) of the now formed pan 122′ (from the pan blank 122) and gasket 124′ (from the gasket blank 124), the adhesive material of the adhesive material member 144 does not reside under the trim line of the die. As a result, the adhesive member 144 does not get trimmed in the trim die. This eliminates the potential to contaminate the trim die with the adhesive material from the adhesive member 144.

Since the edges 145a, 145b of the adhesive member 144 are designed to be slightly inward of the periphery (defined by the edges 164) of the finished assembly or faceplate 160, only a small portion of the gasket 124′ is not permanently attached to the flange portion 128 of the pan 122′ by the adhesive member 144. This adhesive-free area 166 is generally defined by the peripheral design offset between the trim of the adhesive member 144 and the final trimmed pan 122′. In all practicality, the gasket 124′ is fully bonded to the pan 122′, and the adhesive-free area 166 of the gasket 124′ is of limited, if any, movement.

Thus, there has been shown and described a process for manufacturing a faceplate from a universal pan blank (pan) and a universal gasket blank (gasket), which fulfills all the objects and advantages sought therefor. It is apparent to those skilled in the art, however, that many changes, variations, modifications, and other uses and applications to the universal gasket and pan are possible, and also such changes, variations, modifications, and other uses and applications which do not depart from the spirit and scope of the invention are deemed to be covered by the invention, which is limited only by the claims which follow.

1. A process for forming a faceplate member, comprising:
providing a pan blank;
providing a gasket blank;
attaching the gasket blank to the pan blank to form a subassembly; and
cutting the subassembly to form a unitary pan and gasket member with substantially coincident peripheral edges.

2. The process of claim 1, additionally comprising: providing an adhesive member and placing the adhesive member intermediate the gasket blank and the pan blank prior to attaching the gasket blank to the pan blank.

3. The process of claim 2, wherein the gasket blank is dimensioned such that when attached to the pan blank, the gasket blank extends beyond the pan blank.

4. The process of claim 1, wherein the gasket blank includes a first layer of adhesive material and a second layer of gasket material.

5. The process of claim 4, wherein the attaching the gasket blank to the pan blank includes placing the first layer of the gasket blank into contact with the pan blank.

6. The process of claim 5, wherein the gasket blank is dimensioned such that when attached to the pan blank, the gasket blank extends beyond the pan blank.

7. The process of claim 3, wherein the pan blank includes a recessed portion and the gasket blank includes an internal opening correspondingly configured to said recessed portion, and the attaching the gasket blank to the pan blank includes aligning the recessed portion of the pan blank with the internal opening of the gasket blank.

8. The process of claim 7, wherein the cutting the subassembly includes cutting the sub assembly such that the peripheral edges extend beyond the peripheral edges of the adhesive member.

9. The process of claim 6, wherein the pan blank includes a recessed portion and the gasket blank includes an internal opening correspondingly configured to said recessed portion, and the attaching the gasket blank to the pan blank includes aligning the recessed portion of the pan blank with the internal opening of the gasket blank.

10. A faceplate subassembly, comprising:
a pan blank of a first predetermined configuration;
a gasket blank of a second predetermined configuration; and
the pan blank attached to the gasket blank such that upon trimming the subassembly into a third predetermined configuration, different than the first predetermined configuration and the second predetermined configuration, the peripheral edges of the gasket blank are substantially coincident with the peripheral edges of the pan blank.

11. The faceplate subassembly of claim 10, wherein the gasket blank includes a first layer of adhesive material and a second gasket sheet layer.

12. The faceplate subassembly of claim 11, wherein the pan member includes an inward recessed portion and the gasket blank includes an opening correspondingly configured with respect to the recessed portion.

13. The faceplate subassembly of claim 10, additionally comprising:
a double backed adhesive member for connecting the pan blank to the gasket blank.

14. The faceplate subassembly of claim 11, wherein the pan member includes an inward recessed portion and the gasket blank includes an opening correspondingly configured with respect to the recessed portion.

15. The faceplate subassembly of claim 11, wherein the pan member includes an inward recessed portion and the adhesive member includes an opening correspondingly configured with respect to the recessed portion.

16. The faceplate subassembly of claim 13, wherein the adhesive member includes an outer periphery of a predetermined configuration corresponding to the third predetermined configuration.

17. A faceplate assembly formed from a process comprising:
providing a pan blank;
providing a gasket blank;
attaching the gasket blank to the pan blank to form a subassembly; and
cutting the subassembly to form a unitary pan and gasket member with substantially coincident peripheral edges.

18. The assembly of claim 17, additionally comprising: providing an adhesive member and placing the adhesive member intermediate the gasket blank and the pan blank prior to attaching the gasket blank to the pan blank.

19. The assembly of claim 18, wherein the gasket blank is dimensioned such that when attached to the pan blank, the gasket blank extends beyond the pan blank.

20. The assembly of claim 17, wherein the gasket blank includes a first layer of adhesive material and a second layer of gasket material.

21. The assembly of claim 20, wherein the attaching the gasket blank to the pan blank includes placing the first layer of the gasket blank into contact with the pan blank.

22. The assembly of claim 21, wherein the gasket blank is dimensioned such that when attached to the pan blank, the gasket blank extends beyond the pan blank.

23. The assembly of claim 19, wherein the pan blank includes a recessed portion and the gasket blank includes an internal opening correspondingly configured to said recessed portion, and the attaching the gasket blank to the pan blank includes aligning the recessed portion of the pan blank with the internal opening of the gasket blank.

24. The assembly of claim 23, wherein the cutting the subassembly includes cutting the subassembly such that the peripheral edges extend beyond the peripheral edges of the adhesive member.

25. The assembly of claim 22, wherein the pan blank includes a recessed portion and the gasket blank includes an internal opening correspondingly configured to said recessed portion, and the attaching the gasket blank to the pan blank includes aligning the recessed portion of the pan blank with the internal opening of the gasket blank.
